(19) United States
(12) Patent Application Publication
(10) Pub. No.: US 2006/0015457 A1
(43) Pub. Date: Jan. 19, 2006

(54) Method and system for product distribution and billing

(75) Inventors: James Thomas Hau, Green Bay, WI (US); William Robert Pingel, Appleton, WI (US); Kimberly Allison Eschenbach, Green Bay, WI (US); Lincoln Waterman Ward III, De Pere, WI (US)

Correspondence Address: UNILEVER INTELLECTUAL PROPERTY GROUP, 700 SYLVAN AVENUE,, BLDG C2 SOUTH, ENGLEWOOD CLIFFS, NJ, 07632-3100, US

(73) Assignee: Good Humor - Breyer's Ice Cream

(21) Appl. No.: 10/882,921

(22) Filed: Jul. 1, 2004

(51) Int. Cl. G06Q 40/00

(52) U.S. Cl. 705/40

(57) ABSTRACT

A process of, and system for, product distribution and billing. The process comprises: a) distributor delivery of product(s) to customers; b) provider receiving through a website a notification from the distributor that the distributor has delivered product; c) provider issuing credit to the distributor as compensation for both the delivered product value and the services rendered; d) providing visibility to distributors, via the website, of earned credits, and e) provider issuing an invoice to the customer directly. The system includes one or more computers capable of hosting a web page and of retaining information concerning distributors, customers and/or products.

### BACKGROUND OF THE INVENTION

Everyone familiar with current business practices is aware of the attention devoted to minimizing costs and raising margins. Many businesses today are relentless in their efforts to drive down costs to satisfy shareholder demands for higher profits. Each step which can be eliminated and every second which is saved can help contribute to an improved corporate balance sheet and income statement.

Businesses have increasingly looked to the internet to help them streamline their processes. One such process for which improvement is desirable involves processing of goods for customers. Products need to be moved from a product provider, such as a manufacturer, to the provider's customer(s). The provider may, for instance, be the actual manufacturer, or a “manufacturer” in whose name the product is sold but who chooses to have his products made for him. Or, the provider may be another distributor within the distribution chain.

The provider's customers are generally distributors and retailers. Retailers, in turn, sell to the “consumers,” who are typically end users. It is desirable to minimize the number of steps in this distribution, sales and billing process, as well as the time expended in each step.

Numerous patent documents have published in recent years which are directed to internet- or other computer-based systems for conducting business.

Schuh et al. U.S. patent application Pub. No. U.S. 2004/0102981 discloses a system for managing vendor data which includes a vendor component owned by the owner and accessible to the vendor and an owner component controlled by the owner and inaccessible to the vendor. The owner component is adapted to permit the owner to enter owner-supplied data describing the vendor and adapted to allow the owner to review the vendor-supplied and owner-supplied data.

Tolson U.S. Patent Application Pub No. 2004/0098349 is directed to a system for providing a persistent graphical agent linked to accounts enabling a user to access one or more accounts. Tolson discloses in FIG. 2 a method of making a purchase using an agent.

Haynes et al. U.S. Patent Application Pub No. 2004/0098315 is directed to a method for managing the sale of a plurality of items from a plurality of corresponding suppliers to at least one buyer. The suppliers are able to store at least one catalogue of items in a database and to respond to a search request of a buyer to identify any item in the catalogues with a description which matches the item description of the buyer.

Teller U.S. Patent Application Pub. No. 2004/0093233 is directed to a virtual product distribution system supporting on-line sales wherein customers place orders for the purchase of products. A distributor is informed of the order and the customer receives a receipt code from the retailer. When the distributor delivers the product to the customer, the customer provides the distributor with the receipt code which the distributor returns to the retailer as proof of delivery. The retailer then compensates the distributor for the delivery of the product.

Boyert et al. U.S. Patent Application Pub. No. U.S. 2002/0082887 discloses a distribution system for electronic orders wherein goods are transported to predetermined delivery points for pickup by the user.

Kanno U.S. Patent Application Pub. No. U.S. 2002/0038425 is directed to a distributed order processing system for receiving orders over the internet.

Rive et al. U.S. Pat. No. 6,618,706 is directed to a “Method and System for Allocating and Distributing Royalty/Commission Payments to Resellers/Distributors.”

Chu et al. U.S. Patent Application Pub. No. U.S. 2003/0220845 is directed to a method for processing on-line purchases.

Brown et al. U.S. Patent Application Pub. No. U.S. 2003/0074270 is directed to a computerized method for managing and communicating information regarding an order of goods among various teams.

Bong et al. U.S. Patent Application Pub. No. 2004/0084527 discloses an inventory management system.

Zarovinsky U.S. Patent Application Pub. No. 2002/0133415 is directed to a computer-based system for processing orders over the Internet. Order information is sent to at least one supplier associated with the order.

Breaux et al. U.S. Patent Application Pub. No. 2004/0088227 is directed to an order processing system.

Musgrove et al. U.S. Patent Application Pub. No. 2004/0078284 discloses an on-line commerce method and apparatus wherein a user can select products for purchase from plural merchant servers.

Camping et al. U.S. Patent Application Pub. No. 2004/0024711 is directed to a system for repossessing automotive vehicles and trailer mounted boats which involves E-messages sent via the Internet.

Thompson U.S. Patent Application Pub. No. U.S. 2003/0061146 is directed to a system for managing a transaction for a sale of goods between a customer and a merchant. The customer pays the provider and the cost is paid by the provider to the merchant after the merchant delivers the goods. In one embodiment, communications among the customer, provider and merchant are effected through the internet.

Lai U.S. Patent Application Pub. No. U.S. 2003/0204454 discloses a system for managing received orders.

Rime et al. U.S. Patent Application Pub. No. U.S. 2002/0128919 is directed to a method for processing an order within a network.

Paulo et al. U.S. Patent Application Pub. No. U.S. 2002/0198790 is directed to a method and system for ordering goods and services.

Sines et al. U.S. Patent Application Pub. No. 2004/0019563 is directed to methods for purchasing goods or services over the Internet. The customer has an account arranged at a bank with account information, which includes verification information for verification parameters.

At least one company in the US has been invoicing sales to a distributor and then crediting the invoices upon notification that the distributor has delivered the goods, whereupon the retailer is itself invoiced.

### SUMMARY OF THE INVENTION

The present invention is directed to a process and a system for distributing and billing for products. In one aspect, the process includes:
a) Receiving through a website a notification from the distributor that the distributor has delivered product to a customer;
b) Issuing a credit to the distributor; and
c) Issuing an invoice to the customer directly. The process preferably further includes
d) Communicating via a website various information (order information, program information, product information, etc) with both distributors and customers.

The invention is further directed to a system capable of accomplishing the process.

In the process and system of the invention, notification of delivery occurs over the provider's website and a credit can be immediately issued to the distributor. In accordance with a preferred aspect of the invention, the distributor can access, through the website, account information and determine whether it has been issued the credit and, therefore, whether and how much it needs to pay the provider. Because the provider invoices the customer directly, there is no need for invoices from the distributor to the customer (since the distributor has already been compensated for the delivery by the provider). Payments through the chain from customer to distributor to provider can be avoided since the customer will pay the provider directly.

Steps (a), (b), and (c) may be carried out electronically, or otherwise. Carrying out step (b) via a website is particularly useful in that it permits the distributor readily to ascertain that its account has been credited and that it is not necessary to undertake the paperwork needed, nor commit any monetary resource to, paying for products delivered via this system \. Ideally, as many aspects as possible of the invention are effected electronically, preferably through the internet.

The process of the invention is useful in distribution arrangements wherein the distributor distributes to customers it finds to be in need of product during customer calls without any advance specific order, i.e., the so-called “peddle and pack” method, as well as for distribution methods wherein there is first a specific order from the customer.

Typically, the process begins when a distributor delivers product(s) of a provider, usually a manufacturer, to the customer. The customer will typically be a retailer who sells to members of the public, i.e., consumers. The distributor, using browsing software, enters data describing one or more deliveries. Entry by the distributor of the information confirms that a delivery has taken place. Alternatively, the distributor will electronically forward, through the internet, data formatted for file interchange, describing a sequence of deliveries, possibly to multiple customers, for the provider's delivery processing website. Upon delivery, it is preferable that the customer be able to provide unique verification information to the distributor as proof of delivery, generally through the application of a personal signature to a physical delivery document.

Once the provider has been informed, by way of the information that has been forwarded by the distributor, that a product has been delivered to a customer, the system of the invention will create an invoice to the customer, a credit memo to the distributor for the value of the product delivered, and a credit memo to the distributor to compensate the distributor for services rendered in terms of servicing the needs of the customer on behalf of the provider. Alternatively, the system may generate a message or signal prompting someone to create and send the invoice and/or credit memo documents.

Also within the invention is a system capable of accomplishing the above.

In a further preferred aspect of the invention, the process includes, upon receiving the notification of delivery by the distributor, matching delivery information against one or more predetermined criteria and rejecting the delivery information if the one or more predetermined criteria do not match. In such case, the distributor will not be credited for that delivery. Examples of the process of comparing criteria against delivery notification information would include matching customer name and ordered products to a list of permitted products for the customer. In another preferred aspect of the invention, delivery confirmation information is validated against delivery date, customer number, distributor number, delivery ticket number, store location, and product.

The process and system of the invention streamlines the order-filling process, thereby conserving economic and other resources for the provider and the distributor. Typically, the distributor has 30 days (from date of invoice) in which to pay open invoices. If the distributor has delivered product and its entry of delivery information has been accepted into the provider's website, there may be no need to make the payment to the provider. By eliminating the need in some cases for the distributor to pay the provider, working capital is preserved. Instead, the invoiced amount sent from the provider to distributor is, at least partially, offset by a credit once the provider receives delivery information entered by the distributor through the provider's website. Moreover, the system and process of the invention permits billing to be directly between the provider and the customer and eliminates the need for customers of the provider to be billed by anyone other than the provider, e.g., by a plurality of distributors.

In addition to the above features, the system and process of the invention permits immediate identification of problems with a delivery by comparing delivery information input by the distributor with authorized delivery criteria. Such criteria include, in addition to those given above, whether the product is authorized (e.g., is it out of date for delivery date-sensitive products), reasonableness of item quantities delivered, reasonableness of total quantity delivered, valid store identity or distributor identity, valid purchase order (if required), valid unit of measure, reasonableness of delivery date (e.g., is it too soon after previous delivery such that the delivery report must be a duplicate), etc.

The system of the invention includes the equipment necessary to carry out the process, such as the provider's computer, or computers, which store the database of relevant information (e.g., customer names, distributor names, products associated with particular customers, customer number, distributor numbers, etc.), which include the web site and which are capable of receiving inputs from the distributor and/or customer.

The system lends itself to multiple layers of access security and operational control by the provider.

For a more complete of the above and other features and advantages of the invention, reference should be made to the following description of the preferred embodiment.

### DETAILED DESCRIPTION OF THE INVENTION

The system of the invention may include one or more of a computer, or a plurality of linked computers, including a browser-based application capable of collecting data from distributors, additional applications capable of collecting data formatted for electronic data interchange (EDI) or flat-file interchange, a provider data management system linked to the browser-based and additional applications, and a communications link accessible to web browsers or other computing systems of the distributors and possibly also customers.

The computer or computers may be any computing device capable of handling the provider data management system and of serving as a web server. This may be a microprocessor, a minicomputer or a mainframe. The distributor and/or customer's web browser may be situated in a personal computer, a cellular telephone, a personal digital assistant, or other device which is coupled by wire or by wireless connection to an internet service provider (ISP), thereby permitting transmission of data which can be read by the provider's computer.

Typically, the process begins when a distributor delivers product(s) of a provider, usually a manufacturer, to the customer. The customer will typically be a retailer who sells to members of the public, i.e., consumers. The distributor, using browsing software, types in the Uniform Resource Locator (URL) for the provider's delivery processing website. On gaining access to the website, the distributor enters data describing one or more deliveries. Such information may be, for instance, delivery date, customer number, distributor number, delivery ticket number, store location, and product. Entry by the distributor of the information confirms that a delivery has taken place. Alternatively, the distributor will electronically forward, through the internet, data formatted for EDI or flat-file interchange, describing a sequence of deliveries, possibly to multiple customers, for the provider's delivery processing website. Upon delivery, it is preferable that the customer be able to provide unique verification information to the distributor as proof of delivery, generally through the application of a personal signature to a physical delivery document.

Typically, the distributor, the provider and the customer will have different reference numbers assigned to the various parties involved. For example, for a certain provider a given customer may be customer #260, but that same customer may be assigned customer #8432 in the distributor's system. In accordance with one aspect of the invention, a cross reference function is provided to permit the distributor to enter its customer reference number and/or its product number instead of the customer and/or product numbers of the provider. Several variations are possible, but preferred is that the website provide for a distributor designation number after which the distributor can enter its customer number and or product numbers. A cross-reference function receives the distributor's numbers and automatically converts them into the provider's customer and/or product numbers. Of course, the system also permits receipt of the provider's customer and/or product numbers as well. Those of ordinary skill in this art will be able to set up the appropriate tables. The conversion features may be used at any time in the process.

Significantly, the system and process also have the ability to reject delivery information that is incorrect based on predetermined criteria. For instance, if a delivery for a given customer is for a product that for some reason is not on the list of approved products for the customer, the delivery will be rejected.

Once the provider has been informed, by way of the information that has been forwarded by the distributor, that a product has been delivered to a customer, the system of the invention will create an invoice to the customer, a credit memo to the distributor for the value of the product delivered, and a credit memo to the distributor to compensate the distributor for services rendered in terms of servicing the needs of the customer on behalf of the provider. Alternatively, the system may generate a message or signal prompting someone to create and send the invoice and/or credit memo documents.

The system and process also provide a communication platform for the exchange of various information (order information, program information, product information, etc) with both distributors and customers.

It should be understood of course that the specific forms of the invention herein illustrated and described are intended to be representative only, as certain changes may be made therein without departing from the clear teaching of the disclosure. Accordingly, reference should be made to the appended claims in determining the full scope.

What is claimed is:

1. A method and system for product distribution and billing, comprising:
a) Receiving through a website a notification from a distributor that the distributor has delivered product to a customer;
b) Issuing a credit to the distributor; and
c) Issuing an invoice to the customer directly.

2. The process according to claim 1 wherein said delivery notification comprises delivery information.

3. The process according to claim 1 further comprising matching the customer name and delivered products to a list of permitted products for said customer

4. The process according to claim 3 wherein the delivery information is verified against validation criteria including one or more of: delivery date, customer number, distributor number, delivery ticket number, store location, product quantity, product name and product number.

5. The method according to claim 4, further comprised of issuing the credit electronically for the delivered product to the distributor.

6. The method of claim 1 wherein prior to step (a) said order is received from the distributor or a customer through the website.

7. The process according to claim 1 further comprising receiving from the distributor a distributor's product number and converting the distributor's product number to the corresponding provider's product number.

8. The process according to claim 1 wherein the provider is a manufacturer.

9. The process according to claim 1 further permitting access over the website to the distributor's account whereby the distributor can determine through the website whether a credit has issued.

10. A system for processing an order for a product comprising:
one or more computers, optionally linked, capable of:
a) receiving a notification from a distributor through a website that the distributor has delivered a product to a customer; and
b) crediting an invoiced amount to the distributor's account.

11. The system according to claim 10 further permitting access over the website to the distributor's account whereby the distributor can determine through the website whether a credit has been issued.

12. A process for distributing a product, comprising
a) sending an invoice for a product to a distributor;
b) before or after step (a), receiving through a website a notification, comprising delivery information, from the distributor that the distributor has delivered the product to a customer;
c) comparing the delivery information received through the website to one or more predetermined authorized delivery criteria;
d) issuing a credit of the invoice to the distributor if the delivery information matches the authorized delivery criteria and rejecting the delivery notification in the event that the delivery information does not match the authorized delivery criteria.

13. The process according to claim 12 wherein the authorized delivery criteria includes at least the customer name and ordered product and the process further comprises rejecting the delivery notification in the event that the ordered product does not match those permitted for the customer name.

14. The process according to claim 12 wherein the delivery information is verified against validation criteria including: delivery number, customer number, distributor number, delivery ticket number, store location, product quantity, product name and product number and wherein the delivery notification is rejected if the delivery information does not match one or more predetermined criteria.
